(19) United States
(12) Patent Application Publication
(10) Pub. No.: US 2010/0254320 A1
(43) Pub. Date: Oct. 7, 2010

(54) WIRELESS TRANSMITTING APPARATUS, WIRELESS RECEIVING APPARATUS AND WIRELESS COMMUNICATION METHOD

(75) Inventor: Takahisa Aoyama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/438,675

(22) PCT Filed: Aug. 24, 2007
(86) PCT No.: PCT/JP2007/066445

§ 371 Date: Feb. 24, 2009

(30) Foreign Application Priority Data
Aug. 25, 2006 (JP) 2006-229812

(51) Int. Cl. H04W 72/04

(52) U.S. Cl. 370/329

(57) ABSTRACT

Provided is a wireless transmitting apparatus, a wires receiving apparatus and a wireless communication method, by which contents of an RRC message can be changed in retransmission by an RRC and setting corresponding to the change can be efficiently performed. At the time of retransmitting the RRC message from a transmitting apparatus (100), a retransmission message including information (flag) indicating the relation between the SN of the original message which has been transmitted and the original message. Then, a receiving apparatus (150) which received the retransmission message processes the retransmission message, based on the information indicating the relation between the SN of the message which has been received and the message which has been received.

### TECHNICAL FIELD

The present invention relates to a wireless transmitting apparatus, wireless receiving apparatus and wireless communication method.

### BACKGROUND ART

In 3GPP (3rd Generation Partnership Project) UMTS (Universal Mobile Telecommunications System) Release 1999, which has been standardized, RLC (Radio Link Control) plays the role of canceling errors in radio intervals (i.e. recovery). To be more specific, the receiving side reports information about packets that have been received successfully at the receiving side to the transmitting side for a status report, and the transmitting side retransmits packets that have not been received successfully at the receiving side using the result. By this means, packet loss is recovered (for example, see Non-Patent Document 1).

Now, although RLC is employed in LTE (Long Term Evolution), which is being standardized by 3GPP, HARQ (Hybrid ARQ) is employed at all times in LTE unlike UMTS. In HARQ, retransmissions are carried out to recover packet loss. The role of RLC in LTE is to help cases where packet loss cannot be recovered by HARQ. As conditions where error recovery is carried out by RLC in LTE, there are the following cases. The first one is that the retransmission count in HARQ reaches the maximum retransmission count. The second one is that a NACK in HARQ is received as an ACK at the transmitting side. The third one is that the receiving side does not recognize data transmissions from the transmitting side, and the transmitting side detects an ACK by error even though the receiving side has not transmitted either an ACK or NACK.

In these cases, reporting status reports at all times is inefficient, and therefore a simple recovery method is studied in LTE. There are the following two schemes studied for this recovery method.

The first scheme is directed to, as shown in FIG. 1, error detection using SN's (sequence numbers) in RLC/MAC, and is directed to monitoring, at the receiving side, the SN's of transmitted data in RLC/MAC, and, if there is a missing SN, sending a retransmission request for this SN.

The second scheme is directed to, as shown in FIG. 2, error detection using NDI's (new data indicators), and is directed to monitoring, at the receiving side, the NDI's, and, if NDI's are not continuous, reporting back an error. Further, the number of bits for an NDI have not been determined yet (one bit with HSDPA in UMTS).

By employing one of these two schemes, recovery is possible comparatively at ease even when recovery is not possible by HARQ (for example, see Non-Patent Document 2 and Non-Patent Document 3).

However, with these two schemes, although mainly the u-plane (user plane), that is, data, is discussed, the c-plane (control plane), that is, control information, is not discussed well.

The u-plane and c-plane will be briefly described here. The u-plane is transmitted comparatively frequently, so that the above simple recovery that enables error detection when the next data arrives, is effective. Further, if there is an error, the same data needs to be retransmitted every time. Furthermore, the message size (1 IP packet=1500 Kbyte) is greater than the minimum transmission unit, and data is often divided for transmission. Consequently, a retransmission is effective in division units.

On the other hand, the c-plane is transmitted comparatively less frequently, so that the above simple recovery that enables error detection when the next data arrives, is not able to perform long-term detection. Further, when there is an error, retransmitting the same data is not necessarily optimal, and changing the details of the setup upon a retransmission is also possible. Further, the message size is small and control information is not likely to be divided so often. Consequently, there is no difference between retransmissions per division unit and retransmissions per message.

In view of these, retransmissions by RLC are effective for the u-plane but is not so effective for the c-plane.

Therefore, regarding c-plane retransmissions, retransmission processing may be carried out by RRC (radio resource control) for generating control information of c-plane retransmissions. To be more specific, the transmitting RRC (“Tx RRC” in the figure) starts a timer upon transmitting a message and the receiving RRC (“Rx RRC” in the figure) returns a response message upon receiving the message. Then, the transmitting RRC stops the timer upon receiving the response message.

Further, although contents of messages cannot be changed in UMTS, RRC retransmissions are supported only in special cases. The special cases refer to when retransmissions are not possible by RLC, for example, when a RRC connection request, which is a request signal to allow a terminal to access a base station first is transmitted, when cell update, which is a request signal to allow a terminal to find a new cell and access the new cell, is transmitted, and when RLC is reset. In these cases, according to UMTS, without changing RRC SN, transaction ID, which is an information element, is changed. That is, a distinction from an earlier message is drawn by an increment. However, according to this scheme, the RRC SN cannot be used in turn between lower layers (RLC, MAC) (see Non-Patent Document 4), because the difference from an earlier message cannot be identified in lower layers and, if an earlier message has been received successfully, the retransmitted message is decided to be the same message as the earlier message and discarded. Therefore, as described above, the processing of changing the setup upon a retransmission is not possible.

The point here is that the transmitting RRC retransmits the RRC message when a timer expires and a new value needs to be used upon a retransmission for the RRC SN defined for managing the order of messages in RRC. Further, by operating RLC in UM (Unacknowledged Mode), retransmission processing is not carried out, and additional functions for RLC are not necessary.

By this means, an effective retransmission processing is possible for RRC messages which are transmitted less frequently. Further, setting up the timer according to contents of messages is also possible. Furthermore, retransmissions are carried out by RRC itself, so that the contents of messages can be changed.

### Non-Patent Document 1: “Radio Link Control (RLC) Protocol Specification,” TS25.322

Non-Patent Document 2: “HARQ-ARQ interaction,” R2-060826, Nokia, 3GPP TSG-RAN WG2 Meeting# 52
Non-Patent Document 3: “Robustness of HARQ assisted ARQ operation,” R2-060909, Samsung, 3GPP TSG-RAN WG2 Meeting# 52
Non-Patent Document 4: “Using same Sequence Number for ARQ for Security,” R2-061903, ASUSTeK, 3GPP TSG-RAN WG2 LTE adhoc

### DISCLOSURE OF INVENTION

### Problems to be Solved by the Invention

However, in RRC retransmissions, there are the following problems. That is, as shown in FIG. 4, if the reception of a response message from the receiving RRC fails, the transmitting RRC retransmits the RRC message after the timer expires, but because the retransmitted RRC message has be en processed adequately in the receiving RRC, the setup is performed again.

It is there fore an object of the present invention to provide a wireless transmitting apparatus, wireless receiving apparatus and wireless communication method for, in RRC retransmissions, changing the contents of RRC messages and efficiently performing the setup according to the changes.

### Means for Solving the Problem

The wireless transmitting apparatus according to the present invention employs a configuration including: a generating section that, upon a retransmission of a radio resource control message, generates a retransmission message including a sequence number of an original message that has been transmitted earlier and information showing a relationship with the original message; and a transmitting section that transmits the generated retransmission message.

The wireless receiving apparatus according to the present invention employs a configuration including; a receiving section that receives a message including a sequence number of a message that has been received earlier and information showing a relationship with the message that has been received earlier; and a processing section that processes a message that is received currently based on the sequence number of the message that has been received earlier and the information showing the relationship with the message that has been received earlier.

The wireless communication method according to the present invention includes: in a wireless transmitting apparatus, upon a transmission of a radio resource control message, generating a retransmission message including a sequence number of an original message that has been transmitted earlier and information showing a relationship with the original message; transmitting the generated retransmission message to a wireless receiving apparatus; in the wireless receiving apparatus, receiving from the wireless transmitting apparatus a message including a sequence number of a message that has been received earlier and information showing a relationship with the message that has been received earlier; and processing a message that is received currently based on the sequence number of the message that has been received earlier and information showing the relationship with the message that has been received earlier.

### Advantageous Effect of the Invention

The present invention makes it possible to change the contents of RRC messages and perform the setup efficiently according to the changes in RRC retransmissions.

### BRIEF DESCRIPTION OF DRAWINGS

FIG. 1 is a sequence diagram showing a simple recovery method studied in LTE;

FIG. 2 is a sequence diagram showing a simple recovery method studied in LTE;

FIG. 3 is a sequence diagram showing retransmission processing of the c-plane;

FIG. 4 illustrates a problem;

FIG. 5 is a block diagram showing a configuration of a transmitting apparatus according to Embodiments 1, 2 and 3 of the present invention;

FIG. 6 is a block diagram showing a configuration of a receiving apparatus according to Embodiments 1, 2 and 3 of the present invention;

FIG. 7 is a sequence diagram showing an outline of communication steps between the transmitting apparatus shown in FIG. 5 and the receiving apparatus shown in FIG. 6;

FIG. 8 is a sequence diagram in which a flag shows that a message is cancelled;

FIG. 9 is a sequence diagram in which a flag shows that a message is the same as the original message;

FIG. 10 is a sequence diagram in which a flag shows that a message waits for the original message to be processed;

FIG. 11 is a sequence diagram showing that a message type is substituted for a flag;

FIG. 12 is a sequence diagram showing that a terminal fails to receive a handover indication for commanding a handover;

FIG. 13 is a sequence diagram showing that a base station fails to receive a response showing successful reception of the handover indication; and

FIG. 14 is a sequence diagram showing communication steps upon security setup according to Embodiment 3 of the present invention.

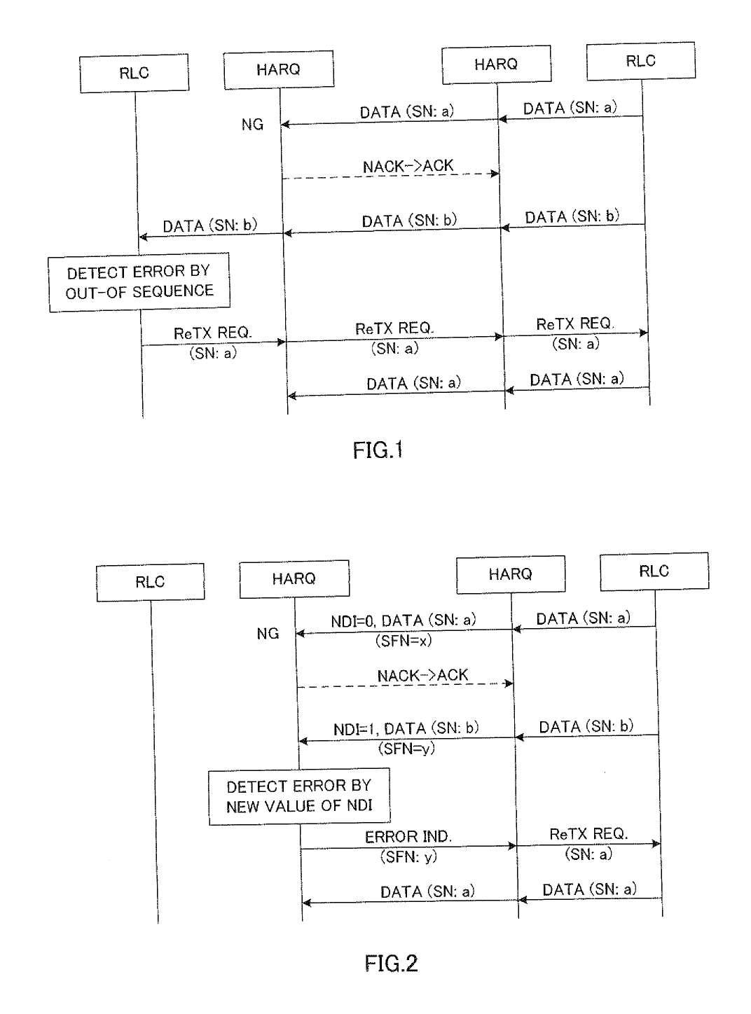

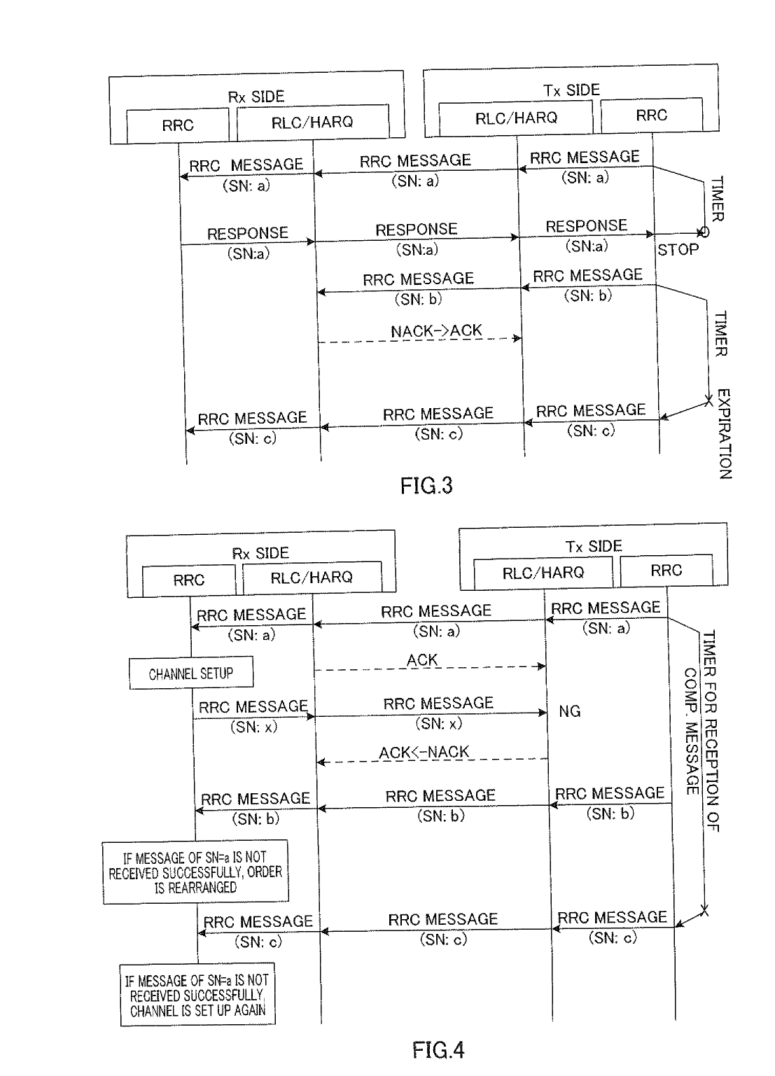

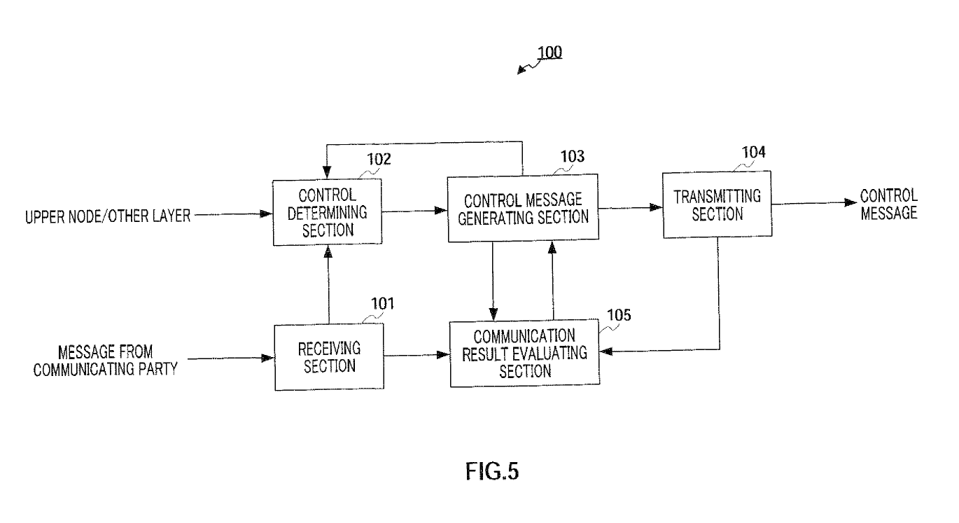

### BEST MODE FOR CARRYING OUT THE INVENTION

Embodiments of the present invention will be described in detail below with reference to the accompanying drawings.

### Embodiment 1

FIG. 5 is a block diagram showing a configuration of transmitting apparatus 100 according to Embodiment 1 of the present invention. In this figure, receiving section 101 receives a message transmitted from the communicating party. Further, a normal message transmitted from the communicating party is outputted to control determining section 102. Furthermore, if a response to the message transmitted from transmitting apparatus 100 is received from a communicating party, the received response is outputted to communication result evaluating section 105.

Control determining section 102 determines the details of control according to commands from an upper node or other layers or messages from the communicating party. The determined details of control are outputted to control message generating section 103.

Control message generating section 103 generates control messages using the details of control outputted from control determining section 102. Further, a result of details of control designated by control determining section 102 is returned to control determining section 102 based on message communication results outputted from communication result evaluating section 105 (described later). Furthermore, an evaluation of the communication results is reported to communication result evaluating section 105 based on information from control determining section 102.

Transmitting section 104 transmits control messages outputted from control message generating section 103 and commands communication result evaluating section 105 to start a timer for managing responses from communicating parties.

Communication result evaluating section 105 is triggered by the command from transmitting section 104 to start the timer and stops the timer when the responses from the communicating parties outputted from receiving section 101 are acquired. Further, information showing whether the timer expires or stops is reported to control message generating section 103 at respective timings.

Next, the operation of transmitting apparatus 100 shown in FIG. 5 will be described in detail. In transmitting apparatus 100, control determining section 102 determines the details of control for the communicating parties. The details of control refer to the details of control in RRC specified by 3GPP, including, for example, channel setup, handover command, channel release command, quality measurement command and quality measurement result report. Further, information providing the basis of this control includes information from an upper node or other layers. To be more specific, when transmitting apparatus 100 is a base station, this information refers to a channel setup command from the upper node (i.e. core network), messages from the core network (because messages from the core network are transmitted through RRC), and quality measurement results from terminals. Further, when transmitting apparatus 100 is a terminal, this information refers to, for example, a call occurrence report from upper layers and quality measurement results from lower layers.

Control determining section 102 reports the details of control determined based on such information to control message generating section 103, and, at the same time, holds the details of control. Further, these details of control are assigned, for example, the ID and delivered such that both control determining section 102 and control message generating section 103 are able to refer to these details of control.

In this way, control determining section 102 checks the details of control against the details of control determined earlier, in addition to the processing of determining the details of control. To be more specific, if the details of setup this time are a re-setup from the last time, the previously transmitted ID and information showing the relationship with the previously transmitted details of control are determined. Then, the determined information is outputted to control message generating section 103 as the details of control.

Control message generating section 103 generates control messages based on the details of control reported from control determining section 102. SN's for identifying between the previously transmitted control messages and the currently transmitting control messages are embedded in the headers of the control messages or in the messages themselves. Further, if related information is outputted from control determining section 102, this related information is embedded in the headers of the control messages or in the messages themselves. The control messages generated in this way are outputted to transmitting section 104.

Transmitting section 104 transmits the messages outputted from control message generating section 103. Transmission here refers principally to delivery to a lower layer, and, although there are cases where addition, encoding and encryption of headers are further carried out in a lower layer, any transmission processing may be carried out in a lower layer. Further, information of the SN of the transmitted message is outputted to communication result evaluating section 105 at the timing of transmission. Further, at this point, for example, timer information (information showing the duration of the timer or the message type) is outputted together.

Further, receiving section 101 also performs delivery to a lower layer, and, although, for example, decoding processing is carried out in a lower layer, any reception processing may be carried out in a lower layer.

Communication result evaluating section 105 starts the timer based on information outputted from transmitting section 104. At this time, the duration of the timer is determined according to timer information outputted from transmitting section 104. To be more specific, if the timer information shows the duration of the timer itself, the timer is set up using its value. On the other hand, if timer information shows the message type, the timer is determined with reference to the timer value per message type set in advance in communication result evaluating section 105.

This timer is stopped according to a response of a communicating party outputted from receiving section 101, and communication result evaluating section 105 reports that a transmission was successfully completed at the timing, to control message generating section 103 using the SN of the message.

Control message generating section 103 reports that control was successfully finished, to control determining section 102 using the ID showing the details of control. By means of this report, control is successfully completed. Further, if the timer expires, communication result evaluating section 105 reports that, in a predetermined period, a transmission was not carried out at the timing, to control message generating section 103 using the SN of the message. As a result, control message generating section 103 reports that control was not carried out in a predetermined period, to control determining section 102 using an ID showing the details of control. The subsequent operations are the above operations upon a retransmission.

Receiving section 101 receives information transmitted from a communicating party. At this time, when a normal message is received from the communicating party, receiving section 101 outputs the received normal message to control determining section 102 and, when a response matching the message transmitted from transmitting apparatus 100 is received, reports the response to reception and the SN of an applicable message and successful reception of the response to communication result evaluating section 105. If a message from the communicating party includes control information in addition to a normal response, receiving section 101 outputs the message itself to control determining section 102 and separately outputs the response to communication result evaluating section 105.

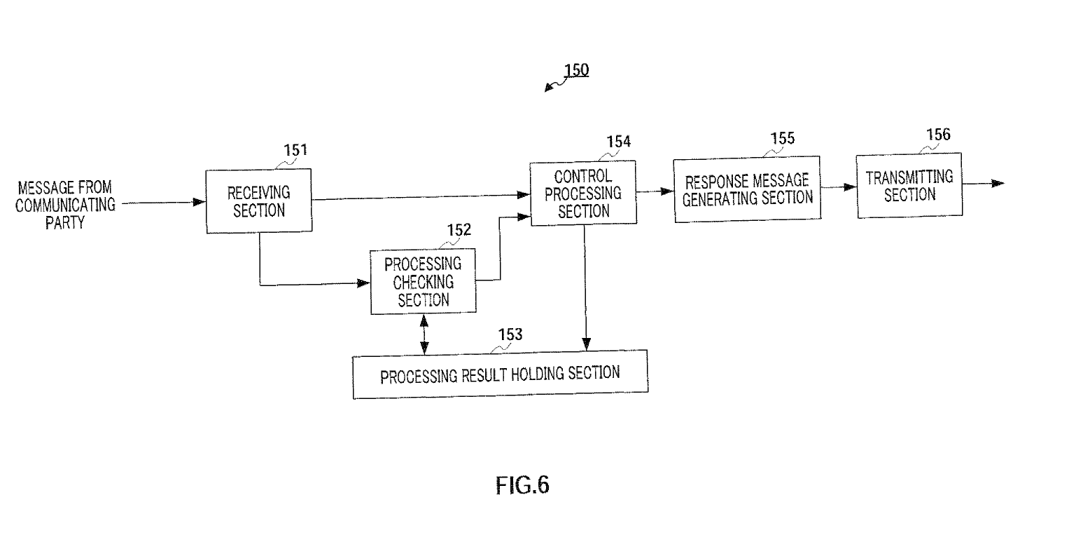

FIG. 6 is a block diagram showing a configuration of receiving apparatus 150 according to Embodiment 1 of the present invention. In this figure, receiving section 151 receives control messages transmitted from transmitting apparatus 100, transmits the control messages to control processing section 154 if there is no information such as a related message, and transmits the control messages to processing checking section 152 if there is information of, for example, related messages.

Processing result holding section 153 holds the details of control processed in control processing section 154 (described later) and the details which are held are checked by processing checking section 152.

Processing checking section 152 checks with processing result holding section 153 to decide whether or not to process the received control messages. If the received control messages are processed, processing checking section 152 reports the details of control to be carried out based on the control message, to control processing section 154, and, if the received control message needs not to be processed, reports to control processing section 154 that the received control message needs not to be processed.

Control processing section 154 executes the control set up in the received control messages and reports the result to response message generating section 155. If the processing is not carried out immediately or takes long time, control processing section 154 reports to response message generating section 155 that the control message is received. Further, information for processing carried out is outputted to processing result holding section 153.

Response message generating section 155 generates a response message showing the result of control processing reported from control processing section 154 and a response message showing the reception result, and outputs the generated response messages to transmitting section 156.

Transmitting section 156 carries out transmission processing of the response messages outputted from response message generating section 155.

Next, the operation of receiving apparatus 150 shown in FIG. 6 will be described in detail. In receiving apparatus 150, receiving section 151 receives the control messages transmitted from transmitting apparatus 100. Here, whether or not the currently receiving control messages are retransmission messages is checked. To be more specific, this results in determining whether or not there is the SN showing related messages in the headers of the control messages or in the messages. If there is the SN, receiving section 151 outputs the currently receiving control messages to processing checking section 152 and, if there is no SN, outputs the currently receiving control messages to control processing section 154.

Processing checking section 152 determines processing according to the relationship between a message related to the current message and the current message. When the details of processing are determined, whether or not the original message has been received successfully is checked. At this time, if the original message has not been received successfully, the current message is reported as is to control processing section 154.

On the other hand, if the original message has been received successfully and the current message shows the same content as the original message, the contents of the current message need not to be executed, and so processing checking section 152 reports this to control processing section 154. Further, in case of a command for executing the setup of the current message instead of the setup of the original message, processing checking section 152 commands control processing section 154 to perform a re-setup using the contents of the current message.

Control processing section 154 processes the control messages outputted from receiving section 151 according to the commands reported from processing checking section 152. The specific details include executing RRC processing specified by 3GPP and reporting to response message generating section 155 that the control message has been received successfully. Further, information of the control messages processed is stored in processing result holding section 153, so that processing checking section 152 can check the information.

Response message generating section 155 generates a response message according to a command from Response messages include a message for simply reporting that the control messages have been received successfully and a message reporting a result of processing the control messages, but both of these messages are generated based on information from control processing section 154. The generated control messages are outputted to transmitting section 156 and are subjected to transmission processing in transmitting section 156.

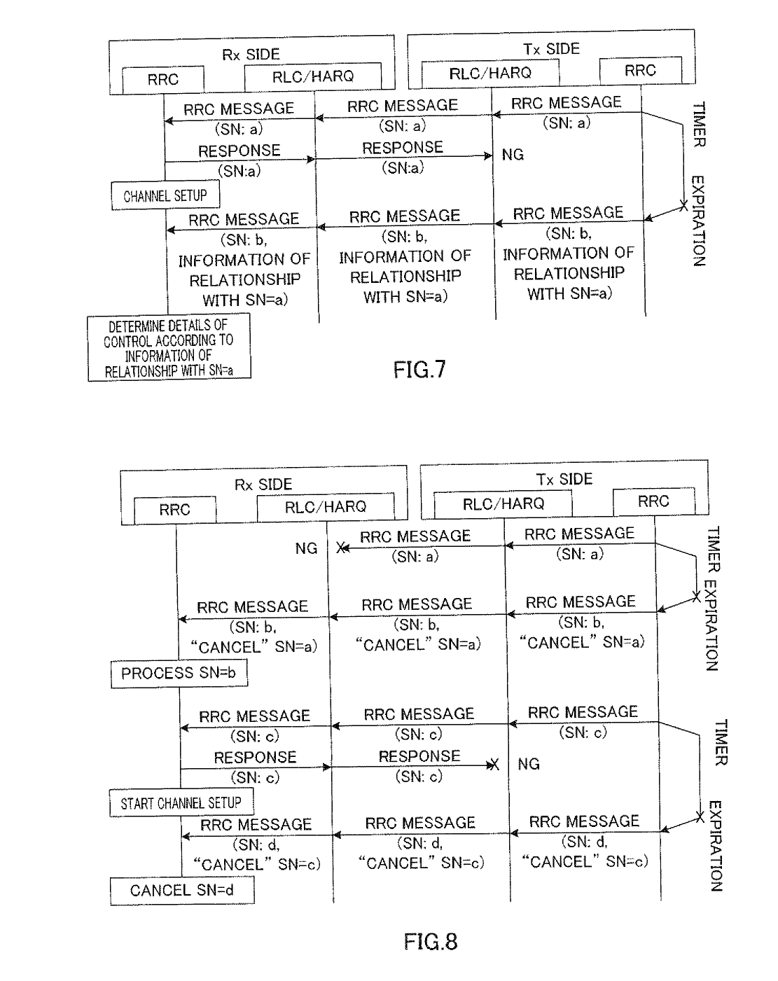

FIG. 7 is a sequence diagram showing an outline of communication steps between transmitting apparatus 100 shown in FIG. 5 and receiving apparatus 150 shown in FIG. 6. When an RRC message is transmitted, if the message is a retransmission message, transmitting apparatus 100 transmits the RRC message including the SN of the original message when a retransmission is carried out, the SN of the original related message and information (i.e. flag) showing the relationship with the message of the SN. This flag may show that, for example, the message of the SN must be cancelled or this message is the same as the message of SN.

If the SN of a related message is included in the received message, receiving apparatus 150 checks information showing the relationship with the message of the SN and determines the processing for the received message based on the check result.

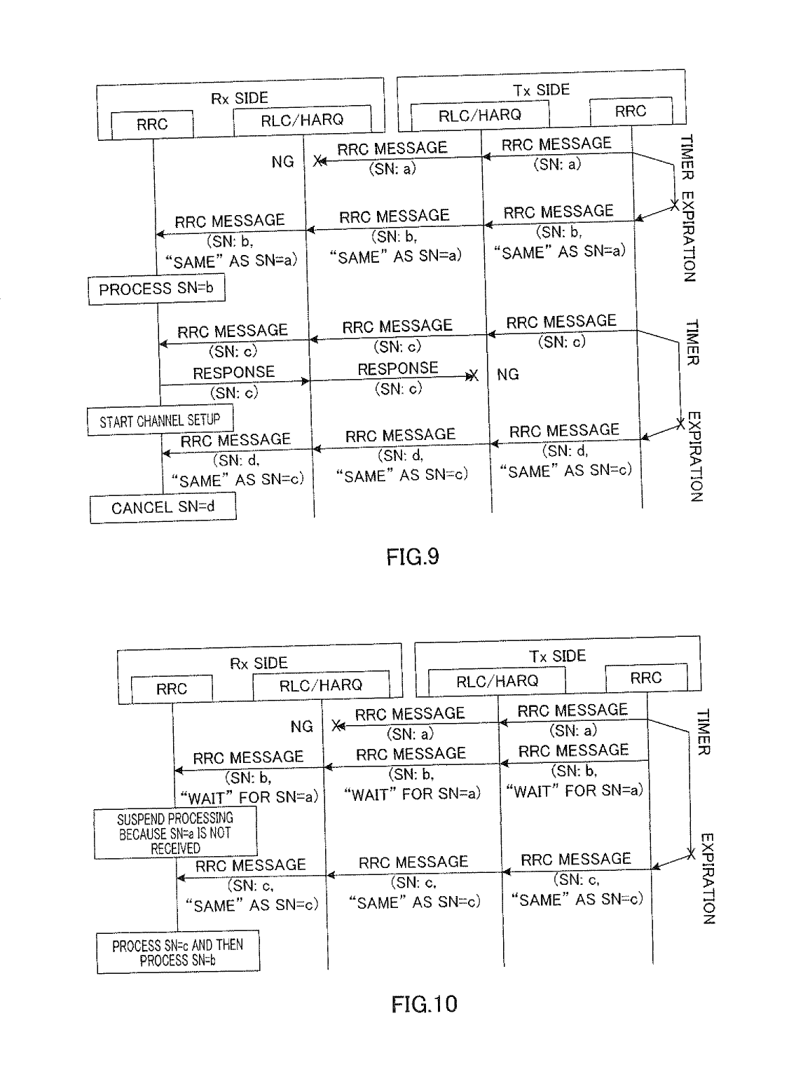

As information shown by the flag, FIG. 8 shows a case where the message of SN is cancelled and FIG. 9 shows a case where this message is the same as the message of the SN.

Further, although the details of processing for the RRC message to be retransmitted has been described with the present embodiment, further improvement is required taking into account a case where other RRC messages are transmitted while the RRC message is retransmitted. To be more specific, improvement is required taking into account the order of processing for RRC messages transmitted while a retransmission is carried out.

That is, even if the order is rearranged due to retransmission in case of an RRC message which needs to be processed after an RRC message transmitted earlier is processed, processing needs to be carried out in the correct order. To be more specific, for example, an NAS message (service accept) needs to be processed after the RB setup message.

In such a case, the SN of a message to be processed preferentially and the flag showing that processing of an RRC message is carried out after processing of a message transmitted earlier may be included in the RRC message to be processed after an RRC message transmitted earlier is processed. This processing may be carried out in control determining section 102.

By this means, as shown in FIG. 10, in case of a message to be processed after a message transmitted earlier is processed, whether or not a message transmitted earlier is processed is checked, and, if the message transmitted earlier is processed, the current message is processed. By contrast with this, if a message transmitted earlier is not processed, processing of the current message is suspended until a message transmitted earlier is processed. This suspension processing can be executed in processing checking section 152 and, if a message transmitted earlier has been processed, that the current message is processed is reported to control processing section 154.

In this way, according to Embodiment 1, when the transmitting apparatus retransmits an RRC message, the transmitting apparatus transmits a retransmission message including the SN of the original message that has been transmitted earlier and information (i.e. flag) showing the relationship with the original message, and the receiving apparatus that receives this retransmission message processes the currently received message based on the SN of the message that has been received earlier and information showing the relationship with the message that has been received earlier, so that it is possible to change the contents of the RRC message and perform the setup according to the changes efficiently.

Further, although, with the present embodiment, control determining section 102 and control message generating section 103 are shown separately, by implementing these two together, the details of control may be managed using only an SN of the message and the ID separately showing the details of control may be omitted.

Further, although an SN is assigned in control message generating section 103, transmitting section 104 may assign an SN. In this case, the result of communication is transmitted from communication result evaluating section 105 to transmitting section 104. Further, the ID showing a control message need to be separately prepared between control message generating section 103 and transmitting section 104 and this ID needs to be used and reported from transmitting section 104 to control message generating section 103. Further, the above two may be combined.

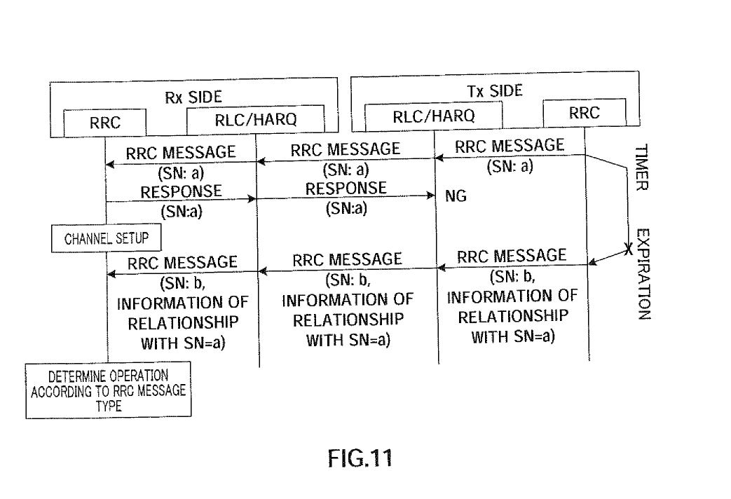

Further, although a case has been described with the present embodiment where a flag showing what processing is carried out is used, processing of a received message may be determined depending on the message type without using this flag. In this case, what operation to be carried out is determined in advance per message type. Although it is generally understood that this determination is performed uniformly for standardization, to enable control of the setup itself may be possible. FIG. 11 shows this concept. As a specific example, it is necessary to perform a new setup at all times for a message for commanding a handover and a message for setting up security. Consequently, the contents of a new retransmitted message are used by discarding a message received earlier and, the message, for which content needs not to be changed much from previous contents for commanding measurement, may use the setup of an earlier message as is if an earlier message has been received.

Further, depending on the form of a message or control, overwriting the same setup may not cause a problem at the receiving side. In this case, if an earlier message needs to be cancelled, that is, if the contents set up in an earlier message is not cancelled, new setup may involve a problem. In such a case, only the SN of a message to be cancelled as a related message needs to be reported and the flag showing the contents matching an earlier message is not necessary. Consequently, if the SN of an earlier message is shown, the receiving side cancels the contents of a message received earlier at all times.

Further, it may be possible that, when the operation of an earlier message is cancelled, instead of canceling the contents of the message entirely, the portion to be cancelled or the portion that can be cancelled and the portion not to be cancelled or the portion that cannot be cancelled, may be separated. That is, the portion to be cancelled or the portion that can be cancelled is cancelled only by reporting the SN of an earlier message, and, if necessary, information showing the relationship with an earlier message, but the portion not to be cancelled or the portion that cannot be cancelled needs to be expressly deleted or overwritten. This portion to be cancelled or portion that can be cancelled and the portion not to be cancelled or portion that cannot be cancelled may be separated between “mandatory” (i.e. mandatory information) and “option” (i.e. optional information) specified in RRC messages or may be separated between “critical information” and “non-critical information” according to ASN.1 used for encoding RRC messages in UMTS, or may be separated by another method.

Further, with the present embodiment, the number of the SN of an earlier message needs not to be limited to one and may be plural. As a specific example, an example may be assumed where, an NAS message is transmitted after an RRC message for commanding measurement is transmitted and neither is returned a response. In such a case, two messages may be transmitted as one message upon a retransmission. Consequently, processing for two messages transmitted earlier is written. Further, if a plurality of earlier messages are shown, the operations which vary between messages are carried out. That is, if the SN's of two previously transmitted messages are included, even if one message shows that an earlier message is received, one message is neglected, but, if the other message shows that an earlier message is received, the current message can be neglected. In such a case, processing at the receiving side becomes complicated, and so restriction may be placed such that messages for carrying out the same processing are combined and transmitted. In this case, even if a flag showing what processing is carried out is required, only one flag is required in the message.

Further, although, with the present invention, the details of control have been described as an example with reference to the contents controlled by RRC specified by 3GPP, the present invention may include, for example, control processing specified by NAS (non-access stratum) which refers to processing of the core network side or may be applied to control including, for example, control processing specified by MAC (medium access control) which is a lower layer. Further, the present invention may be implemented not only by RRC but also by NAS for retransmitting an NAS message or may be implemented in MAC for retransmitting a MAC control signal. Furthermore, the present invention may be applied not only to control information but also to data communication having the property of changing values upon a retransmission. In this case, if communication is carried out between communication terminals, the present function is realized between the communication terminals. Further, if communication is carried out between a communication terminal and a server, the present function is realized by the communication terminal and server. Furthermore, if the present invention is applied to data in this way, by showing the SN's of a plurality of earlier messages as described above, overwriting of files in the middle of communication can be realized.

Further, with the present embodiment, a different RRC SN is used when a retransmission message is transmitted. However, if an RRC SN is not used in the lower layer (RLC MAC), the same RRC SN may be used. That is, the transaction ID indicates a transmission using the same RRC SN. In this case, similarly, the flag showing the relationship with the original message may be introduced or processing is uniquely decided depending on the message type. Further, as the format of a message, different types of transaction ID's may be used between when the same content is retransmitted and when a different value is retransmitted. To be more specific, transaction ID 1 and transaction ID 2 are prepared, and transaction ID 1 is used when the same content is retransmitted and transaction ID 2 is used when different content is retransmitted.

Further, although processing after an RRC message is transmitted has been described with the present embodiment, processing is applicable to the operation before transmission of an RRC message to the communicating party. That is, when an RRC message is delivered to a lower layer (RLC, MAC), the transmission of the RRC message is cancelled before the RRC message is actually transmitted to the communicating party. In this case, the present invention can be used. To be more specific, a new retransmission message and a command for canceling transmission of an earlier message are transmitted at the same time to the lower layer. In this case, there is a possibility that an earlier message has been transmitted from the lower layer. Even in this case, if the relationship with an earlier message is shown as in the present invention, a delivered retransmission message needs only to be transmitted as usual from the lower layer. Consequently, processing can be simplified.

Further, although, with the present embodiment, the operation of returning responses to RRC messages per RRC message has been shown, if a plurality of RRC messages are transmitted at close timings, one response can be used as a response to a plurality of RRC messages.

### Embodiment 2

A case will be described with Embodiment 2 of the present invention where the details described in Embodiment 1 are applied to a handover.

The configurations of the transmitting apparatus and receiving apparatus according to Embodiment 2 of the present invention are the same as the configurations of FIG. 5 and FIG. 6 described in Embodiment 1, and so will be described employing FIG. 5 and FIG. 6. Further, with the present embodiment, the transmitting apparatus is a terminal and the receiving apparatus is a base station.

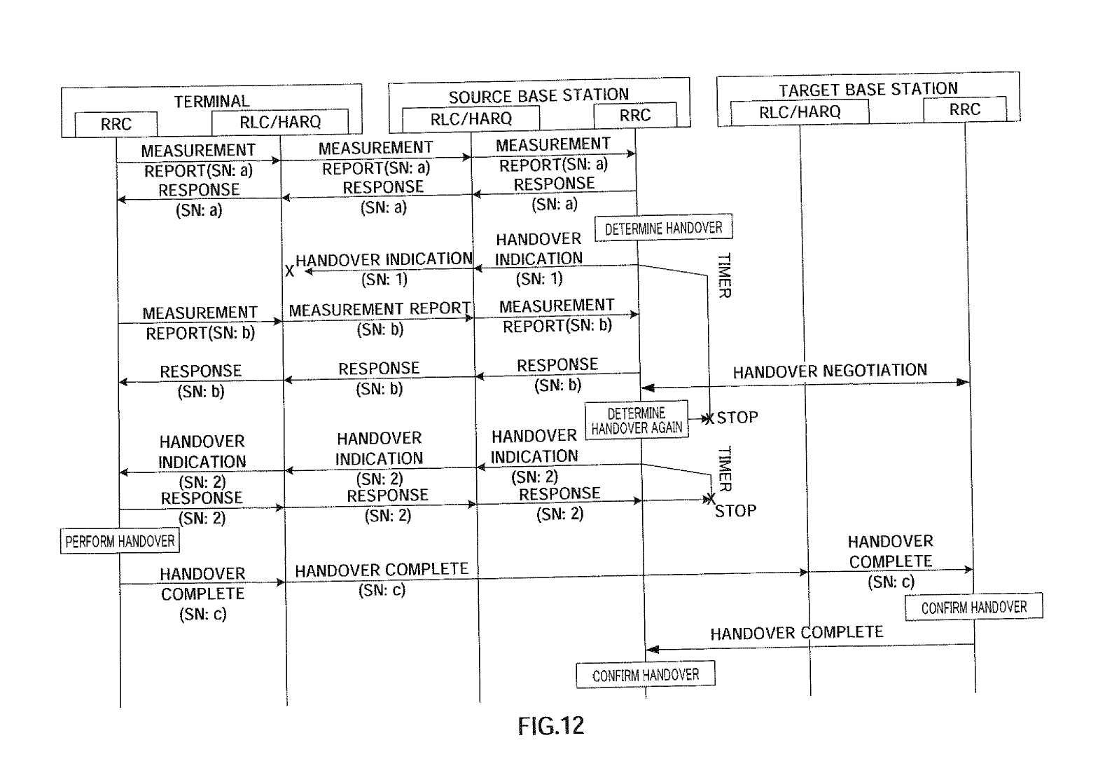

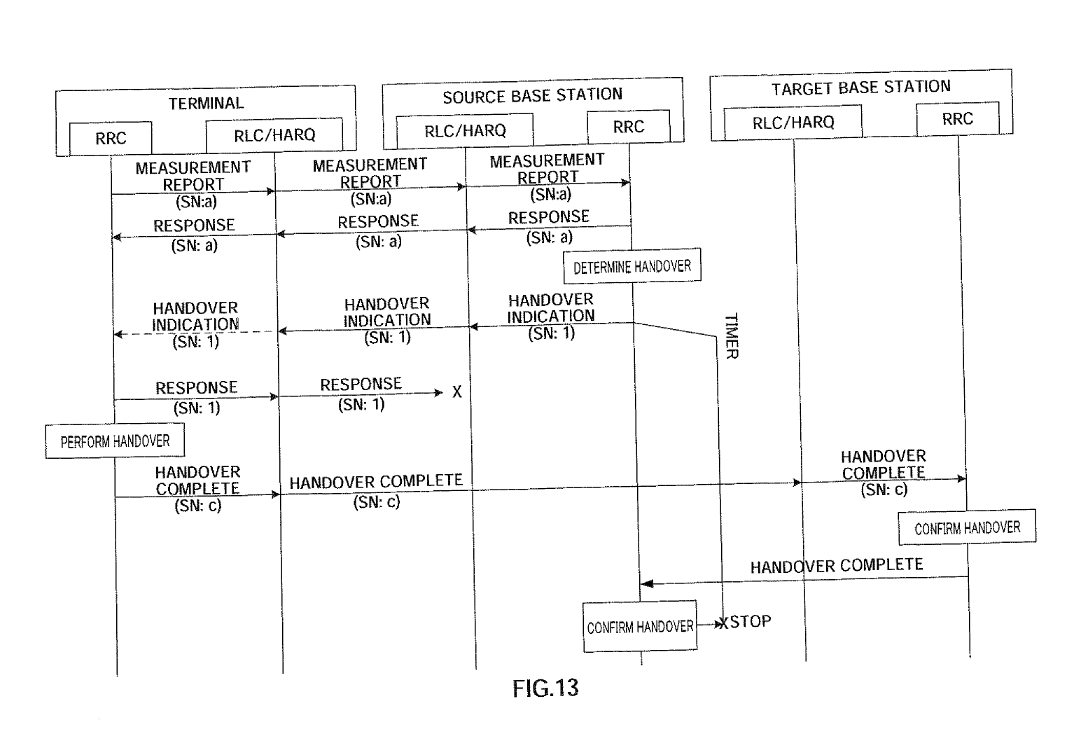

FIG. 12 and FIG. 13 are sequence diagrams showing communication steps upon a handover according to Embodiment 2 of the present invention. Particularly, FIG. 12 shows a case where the terminal fails to receive a handover indication for commanding a handover. Furthermore, FIG. 13 shows a case where the base station fails to receive a response showing successful reception of the handover indication.

In the case shown in FIG. 12, given that the terminal fails to receive a handover indication, the terminal is not able to execute a handover. Consequently, it is generally understood that a message showing a handover is transmitted to the same handover destination again. However, as shown in FIG. 12, a more adequate cell is found by a measurement report while the timer for retransmission is operating, the terminal communicates with the base station that manages the cell and, if negotiation succeeds, the handover indication for the cell can be transmitted. In this case, instead of a command after the timer expires, the handover indication is transmitted immediately after negotiation succeeds.

In the case shown in FIG. 13, given that the base station fails to receive a response showing successful reception of a handover indication, the terminal executes a handover. In this case, the terminal reports the end of a handover, to the target base station that manages a cell of the moving destination using a handover complete. In this way, the target base station is able to confirm the handover and reports the result to the source base station. By this means, the source base station is able to confirm that the handover is finished successfully. Consequently, the timer stops with this confirmation. Therefore, processing is slightly different from a normal case of stopping the timer based on a message from the communicating party. Referring to FIG. 5, as an upper node or other layers, control determining section 102 receives information showing the end of handover. By this means, control determining section 102 is able to recognize that handover control is completed. Consequently, report of control completion and, for example, an ID showing the details of control are transmitted to control message generating section 103. Then, the timer is stopped by reporting control completion from control message generating section 103 to communication result evaluating section 105.

### Embodiment 3

A case will be described with Embodiment 3 of the present invention where the details described in Embodiment 1 are applied to security setup.

The configurations of the transmitting apparatus and receiving apparatus according to Embodiment 3 of the present invention are the same as the configurations of FIG. 5 and FIG. 6 shown in Embodiment 1, and so will be described employing FIG. 5 and FIG. 6. Further, with the present embodiment, the transmitting apparatus is a terminal and the receiving apparatus is a base station.

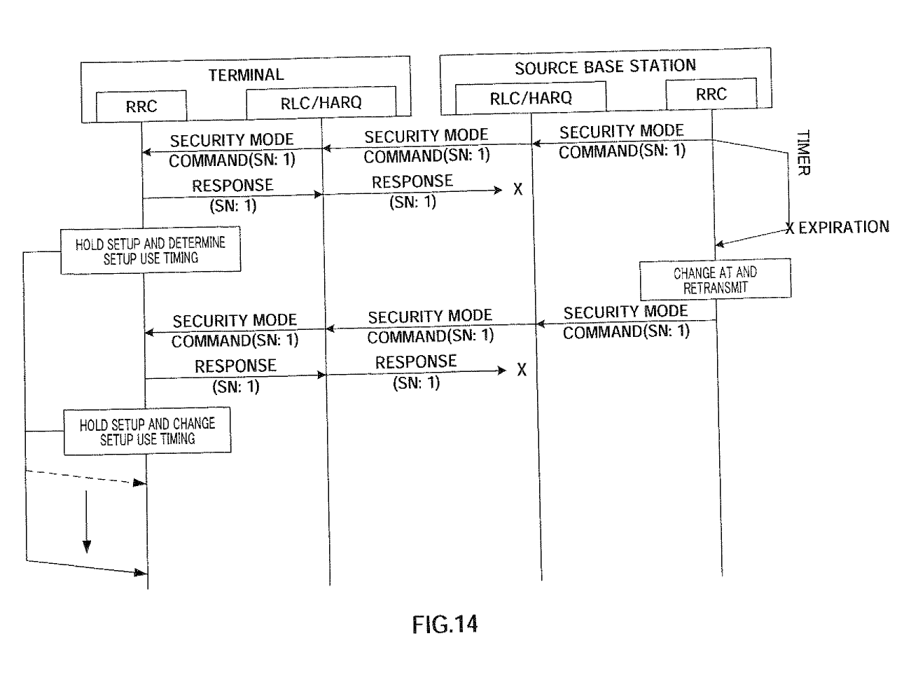

FIG. 14 is a sequence diagram showing communication steps upon security setup according to Embodiment 3 of the present invention.

What is critical in the security-related setup is, for example, timing information for reflecting the details of security setup. This timing is defined as “AT (activation time)” according to 3GPP, and is delivered through an RRC message. This AT needs to adopt a value taking retransmissions into account. That is, the details of security setup needs to be reflected at the same time in the terminal and the base station and, when whether or not the terminal receives the RRC message is not confirmed, it would be a problem if the terminal side sets up security while the timer for a retransmission is operating, and therefore an AT needs to adopt the value longer than the period for carrying out a retransmission. Further, if the same AT is used upon a retransmission, a problem would also be produced when a retransmission is required again. Consequently, as shown in FIG. 14, the value of an AT may further be changed. At this time, even if the terminal has received the first message, when receiving the following message, the terminal operates using the currently receiving setup instead of the previous setup. That is, instead of the value of an AT designated in an earlier message, the value of the AT designated in the current message is used.

Further, as an additional case, there is a possibility that a retransmission message cannot be transmitted correctly. What is a problem in particular is that a response is not returned as shown in FIG. 14 and a retransmission message is not delivered to the terminal. In this case, there is a possibility that the terminal performs the setup using a message received earlier without recognizing a retransmission. To avoid such a case, a timer set up when a retransmission message is transmitted is made shorter than a timer when the first message is transmitted. Consequently, the receiving side (the terminal with the present embodiment) may carry out processing to return a response quickly. As a specific example, in case of the first message, this processing refers to checking the details of processing of the message and then returning a response, and, in case of a retransmission message, if a retransmission is identified, this processing refers to returning a response before checking and processing the contents of the message. Further, the above operation is effective not only for security setup described in the present embodiment but also for other processing required to be carried out at the same time in the base station and terminal.

Furthermore, these details of security setup need not to be changed except an AT. Consequently, instead of inserting AT information inside an RRC message, a method of inserting the AT information in the header of an RRC message may be employed to make retransmissions efficient. By inserting parameters which change upon a retransmission in the header, operations such as processing, encryption and integrity check of an RRC message upon a retransmission can be carried out at ease.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-229812, filed on Aug. 25, 2006, including the specification, drawings and abstract, is incorporated herein by reference in its entirety.

### INDUSTRIAL APPLICABILITY

The wireless transmitting apparatus, wireless receiving apparatus and wireless communication method according to the present invention make it possible to change the contents of an RRC message in RRC retransmissions and efficiently perform a setup according to the changes, and are applicable to, for example, a mobile communication system by the 3GPP.

1. A wireless transmitting apparatus comprising:
a generating section that, upon a retransmission of a radio resource control message, generates a retransmission message including a sequence number of an original message that has been transmitted earlier and information showing a relationship with the original message; and
a transmitting section that transmits the generated retransmission message.

2. The wireless transmitting apparatus according to claim 1, wherein, upon generation of the radio resource control message, if there is a message which comprises the message that has been transmitted earlier and which is related to a message to be generated currently, the generating section generates a message including a sequence number of the related message and information showing a relationship with the related message.

3. The wireless transmitting apparatus according to claim 1, wherein the generating section generates the retransmission message by associating the information showing the relationship with the original message, with a message type.

4. The wireless transmitting apparatus according to claim 2, wherein the generating section generates the message by associating information showing the relationship with the related message, with a message type.

5. A wireless receiving apparatus comprising:
a receiving section that receives a message including a sequence number of a message that has been received earlier and information showing a relationship with the message that has been received earlier; and
a processing section that processes a message that is received currently based on the sequence number of the message that has been received earlier and the information showing the relationship with the message that has been received earlier.

6. The wireless receiving apparatus according to claim 5, wherein the processing section processes the message that is received currently using a message type for the information showing the relationship with the message that has been received earlier.

7. A wireless communication method comprising:
in a wireless transmitting apparatus, upon a transmission of a radio resource control message, generating a retransmission message including a sequence number of an original message that has been transmitted earlier and information showing a relationship with the original message;
transmitting the generated retransmission message to a wireless receiving apparatus;
in the wireless receiving apparatus, receiving from the wireless transmitting apparatus a message including a sequence number of a message that has been received earlier and information showing a relationship with the message that has been received earlier; and
processing a message that is received currently based on the sequence number of the message that has been received earlier and information showing the relationship with the message that has been received earlier.
